(19) United States
(12) Patent Application Publication
(10) Pub. No.: US 2024/0310528 A1
(43) Pub. Date: Sep. 19, 2024

(54) Location Estimation Server, System Including Same And Method Thereof

(71) Applicants: Hyundai Motor Company, Seoul (KR); Kia Corporation, Seoul (KR)

(72) Inventors: Ga Hee Kim, Seoul (KR); Yun Sub Kim, Suwon-Si (KR); Hwan Hee Lee, Gunpo-Si (KR); Seung Yong Lee, Uiwang-Si (KR)

(21) Appl. No.: 18/384,162

(22) Filed: Oct. 26, 2023

(30) Foreign Application Priority Data
Mar. 17, 2023 (KR) 10-2023-0035344

(51) Int. Cl. G01S 17/894; G01S 7/497

(52) U.S. Cl. CPC G01S 17/894; G01S 7/497

(57) ABSTRACT

A server may include one or more processors, and memory storing instructions that, when executed by the one or more processors, cause the server to, collect, from a first mobile device, location information associated with a specified area, store reference data, associated with a relative location between a second mobile device and the specified area, determine, based on at least one of the location information or the stored reference data, whether an error calculated satisfies a threshold value, generate, based on the determination, new reference data, and cause, based on the new reference data and the location information, the second mobile device to adjust driving direction.

### CROSS-REFERENCE TO RELATED APPLICATION

This application claims the benefit of priority to Korean Patent Application No. 10-2023-0035344, filed in the Korean Intellectual Property Office on Mar. 17, 2023, the entire contents of which are incorporated herein by reference.

### TECHNICAL FIELD

The present disclosure relates to a location estimation server, a system including the same, and a method thereof, and more particularly, to a technology for generating reference data for driving of a specific mobile device by using data obtained through a plurality of mobile devices (e.g., mobile robots) including different sensors and distributing the reference data to the specific mobile device.

### BACKGROUND

With the development of technology, various technologies related to mobile devices (e.g., mobile robots) may be used. For example, as more data may be used to control the driving of a mobile device to a destination, various schemes for processing data may be used.

For example, a mobile device may store data (e.g., map data on a specific place) prepared for driving to a specific place. For example, a mobile device may include at least one sensor that senses information about an area proximate to the mobile device. For example, a mobile device may perform a function of estimating a location of the mobile device by using pre-stored data and data obtained through at least one sensor while driving in a specific place.

For example, after a mobile device ends driving and stores the location of the mobile device immediately before the power is turned off, the mobile device may search for an area adjacent to the stored location, or estimate and/or identify the current location of the mobile device through a location specified input received from a user.

However, the location estimation function of a mobile device described above has poor accuracy or has the inconvenience of receiving a user's input. For example, if the mobile device is moved, by the user, to a location different from the stored location after the power of the mobile device is turned off, an error occurs in the location estimation result. For example, if a location where a mobile device exists is a place (e.g., a hallway) where a similar pattern is repeated, as the number of candidates for a location estimated as the location of the mobile device increases, an error occurs or accuracy decreases in the location estimation result. Accordingly, the problem may be solved to some extent by mounting a sensor with high accuracy in the mobile device, but mass production may be difficult in such a scheme because the production cost of the mobile device increases.

### SUMMARY

According to the present disclosure, a server may comprise: one or more processors; and memory storing instructions that, when executed by the one or more processors, cause the server to: collect, from a first mobile device, location information associated with a specified area; store reference data, associated with a relative location between a second mobile device and the specified area; determine, based on at least one of the location information or the stored reference data, whether an error calculated satisfies a threshold value; generate, based on the determination, new reference data; and cause, based on the new reference data and the location information, the second mobile device to adjust driving direction.

The instructions, when executed by the one or more processors, may further cause the server to cause the first mobile device to collect, by a first sensor device, the location information; wherein the stored reference data is used to control driving the second mobile device; and wherein a second sensor device, associated with the second mobile device, has a lower performance than the first sensor device. The instructions, when executed by the one or more processors, may further cause the server to replace the stored reference data with the new reference data based on: a difference between the stored reference data and the new reference data satisfying a specified range; or a specified period of time.

The location information may include at least one of: identification information of at least one corridor included in the specified area, at least one image used for estimating a location of the first mobile device, an optical character recognition (OCR) result based on the at least one image, 2 dimensional lidar data, or 3 dimensional lidar data. The instructions, when executed by the one or more processors, further may cause the server to calculate the error based on data included in the location information and data included in the stored reference data.

The at least one of the stored reference data or the new reference data may include at least one of: identification information of at least one corridor included in the specified area, a location of at least one landmark, or location conversion information that is based on the location of the at least one landmark. The instructions, when executed by the one or more processors, further may cause the server to: extract at least one feature from at least one image included in the location information; and generate the new reference data that includes the at least one feature and is different from the stored reference data, and store the new reference data separately from the stored reference data; or generate the new reference data by replacing a reference feature included in the stored reference data with the at least one feature.

The instructions, when executed by the one or more processors, further may cause the server to: generate the new reference data that includes at least one of 2 dimensional (2D) lidar data or 3 dimensional (3D) lidar data included in the location information and is different from the stored reference data, and store the new reference data separately from the stored reference data; or generate the new reference data by replacing reference lidar data included in the stored reference data with at least one of the 2D lidar data or the 3D lidar data.

The instructions, when executed by the one or more processors, further may cause the server to: update at least one machine learning model based on at least one image included in the location information as learning data and the error satisfying the threshold value; and generate, based on the updated at least one machine learning model, at least one reference datum. The instructions, when executed by the one or more processors, further may cause the server to distribute the new reference data to the second mobile device based on: a difference between the stored reference data and the new reference data satisfying a specified range; or a specified period of time.

According to the present disclosure, a system may comprise: a first mobile device configured to obtain, by a first sensor device, location information associated with a specified area; a server configured to: collect the location information from the first mobile device, store reference data, associated with a relative location between a second mobile device and the specified area, generate new reference data based on the location information and an error associated with the location information and the stored reference data satisfying a threshold value, and distribute the new reference data to the second mobile device; and the second mobile device associated with a second sensor device having lower performance than the first sensor device and the second sensor device configured to identify a current location information based on the new reference data distributed from the server.

The second mobile device may be configured to: sense, by the second sensor device, information associated with at least one landmark existing in the specified area, and estimate location of the second mobile device based on at a current least one of the new reference data or the information associated with the at least one landmark.

The second mobile device may be configured to: identify, by the second sensor device, a first zone in which the second mobile device travels in the specified area; identify, by the second sensor device, first height information associated with a first landmark, among the at least one landmark, existing in the first zone; identify location information corresponding to the first height information based on at least one of zone information included in the new reference data, landmark identification information, or location conversion information, and identify the current location of the second mobile device based on the location information.

The second mobile device may be configured to: perform interpolation based on the new reference data if the first height information is not identified in the new reference data; and identify, based on the interpolation, the current location of the second mobile device. The first sensor device may include at least one of a 3 dimensional (3D) lidar or a 3D camera, and wherein the second sensor device includes at least one of a 2 dimensional (2D) lidar or a 2D camera.

According to the present disclosure, a method may comprise: collecting, by a server from a first mobile device, location information associated with a specified area; storing reference data, associated with a relative location between a second mobile device and the specified area; determining, based on at least one of the location information or the stored reference data, whether an error calculated satisfies a threshold value; generating, based on the determination, new reference data; and causing, based on the new reference data and the location information, the second mobile device to adjust driving direction.

The generating the new reference data may comprise: extracting at least one feature from at least one image included in the location information; and generating the new reference data that includes the at least one feature and is different from the stored reference data and, storing the new reference data separately from the stored reference data; or generating the new reference data by replacing a reference feature included in the stored reference data with the at least one feature.

The generating of the new reference data may comprise: generating the new reference data that includes at least one of 2 dimensional (2D) lidar data or 3 dimensional (3D) lidar data included in the location information and is different from the stored reference data, and storing the new reference data separately from the stored reference data; or generating the new reference data by replacing reference lidar data included in the stored reference data with at least one of the 2D lidar data or the 3D lidar data.

The generating the new reference data may comprise: updating at least one machine learning model based on at least one image included in the location information as learning data and the error satisfying the threshold value; and generating, based on the updated at least one machine learning model, at least one reference datum. The method further comprising: distributing the new reference data to the second mobile device based on: a difference between the stored reference data and the new reference data satisfying a specified range; or a specified period of time.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a location estimation system according to an example of the present disclosure;

FIG. 2 shows an example of components of a mobile device according to an example of the present disclosure;

FIG. 3 shows an example of types of mobile devices and characteristics of each mobile device according to an example of the present disclosure;

FIG. 4 shows an example of landmarks of a zone in which a mobile device is to travel and characteristics of each mobile device according to an example of the present disclosure;

FIG. 5 shows an example of a location estimation operation of a mobile device according to an example of the present disclosure;

FIG. 6 shows an example of an operation of a location estimation server according to an example of the present disclosure;

FIG. 7 shows an example of an operation of a location estimation server according to an example of the present disclosure; and

FIG. 8 shows an example of a computing system for executing a location estimation method according to an example of the present disclosure.

With regard to description of drawings, the same or similar elements may be marked by the same or similar reference numerals.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral even if they are displayed on other drawings. Further, in describing the example of the present disclosure, a detailed description of the related known configuration or function will be omitted if it is determined that it interferes with the understanding of the example of the present disclosure.

In describing the components of the example according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

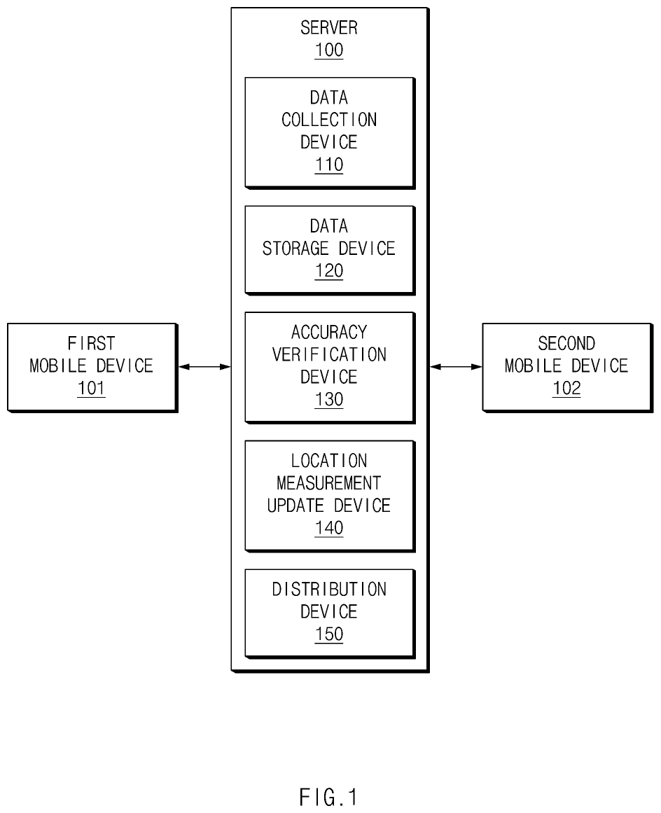

Hereinafter, examples of the present disclosure will be described in detail with reference to FIGS. 1 to 8.

FIG. 1 shows an example of components of a location estimation system according to an example of the present disclosure.

According to an example, a location estimation system may include at least one of a server 100, a first mobile device 101, a second mobile device 102, or a combination thereof.

According to an example, the server 100 may include a location estimation server that communicates with at least one mobile device and transmits and receives various data for driving of the at least one mobile device.

According to an example, the server 100 may include at least one of a data collection device 110, a data storage device 120, an accuracy verification device 130, a location measurement update device 140, a distribution device 150, or a combination thereof.

For example, the server 100 may use the data collection device 110 to collect data obtained by the first mobile device 101 and/or the second mobile device 102 from the first mobile device 101 and/or the second mobile device 102.

For example, the server 100 may use the data collection device 110 to collect (or receive) location information about a specified area that the first mobile device 101 obtains using a first sensor device. For example, the first sensor device may include at least one sensor having higher performance (or higher price) than a second sensor device included in the second mobile device 102.

For example, the location information may include at least one of identification information of at least one corridor included in the specified area, at least one image used for estimating a location of the first mobile device 101, an optical character recognition (OCR) recognition result based on at least one image, 2D lidar data, 3D lidar data, or a combination thereof.

For example, the server 100 may store reference data on a specified area used for estimating a location of the second mobile device 102 by using the data storage device 120.

For example, at least one of identification information of the at least one corridor included in the specified area, a location of at least one landmark, location conversion information calculated based on the location of the at least one landmark, or a combination thereof may be included.

For example, the data storage device 120 may replace and store reference data with new reference data if a difference between the reference data and the new reference data exceeds a specified range.

For example, the data storage device 120 may replace and store reference data with new reference data based on a specified period. The specified period may be a setting value set by the user.

For example, the server 100 may determine, through the accuracy verification device 130, whether an error calculated by using at least one of location information, reference data, or a combination thereof exceeds a threshold value.

For example, the server 100 may calculate an error between at least some of the data included in the location information and data on a specified area included in the reference data through the accuracy verification device 130. The reference data may include, for example, pre-stored map data for driving of at least one mobile device.

For example, the server 100 may generate new reference data through the location measurement update device 140 by using location information if the error calculated through the accuracy verification device 130 exceeds a threshold value.

For example, the new reference data may include at least one of identification information of at least one corridor included in a specified area, location of at least one landmark, location conversion information calculated based on the location of the at least one landmark, or a combination thereof. For example, the new reference data may include an updated value of at least one of the above-described parameters included in the reference data.

For example, the new reference data may include reference data for driving of the second mobile device 102 including a sensor device having relatively low performance (or low price) compared to the first mobile device 101.

For example, the server 100 may generate new reference data by using the location measurement update device 140 and store the new reference data in the data storage device 120.

For example, the server 100 may extract at least one feature from at least one image included in the location information by using the location measurement update device 140.

For example, the server 100 may generate new reference data that includes at least one feature and is distinguished from reference data by using the location measurement update device 140, and may store the generated new reference data in the data storage device 120 and/or in a separate memory (not shown) distinguished from the data storage device 120.

For example, the server 100 may generate new reference data by replacing the reference feature e included in the reference data with at least one feature by using the location measurement update device 140, and store the generated new reference data in the data storage device 120 and/or a separate memory (not shown) distinguished from the data storage device 120.

As an example, the server 100 may use the location measurement update device 140 to generate the new reference data that includes at least one of 2D lidar data, 3D lidar data or a combination thereof included in the location information and is distinguished from the reference data, and may store the generated new reference data in the data storage device 120 and/or a separate memory (not shown) distinguished from the data storage device 120.

For example, the server 100 may replace the reference lidar data included in the reference data with at least one of 2D lidar data, 3D lidar data, or a combination thereof by using the location measurement update device 140 to generate new reference data, and may store the generated new reference data in the data storage device 120 and/or a separate memory (not shown) distinguished from the data storage device 120.

For example, the location measurement update device 140 may include at least one machine learning model.

For example, the location measurement update device 140 may generate new reference data by using at least one machine learning model.

For example, if the error calculated through the accuracy verification device 130 exceeds a threshold value, the location measurement update device 140 may use at least one image included in the location information as learning data for at least one machine learning model to update the at least one machine learning model.

For example, the server 100 may distribute (or transmit) the new reference data generated to the first mobile device 101 and/or the second mobile device 102 through the distribution device 150.

For example, the distribution device 150 may establish a communication channel (e.g., a wireless communication channel) between the server 100 and an external device (e.g., the first mobile device 101 and/or the second mobile device 102) and may support communication through the established communication channel. For example, the distribution device 150 may include one or more communication processors that operate independently from other components of the server 100 and support direct (e.g., wired) communication or wireless communication.

For example, the distribution device 150 may include a wireless communication module (e.g., a cellular communication module, a near field wireless communication module, or a global navigation satellite system (GNSS) communication module) or a wired communication module (e.g., a local area network (LAN) communication module, or a power line communication module). Among such communication modules, a corresponding communication module may communicate with an external device through a first network (e.g., a near field communication network such as Bluetooth, wireless fidelity (Wi-Fi) direct, or infrared data association (IrDA)) or a second network (e.g., a wide area network such as a legacy cellular network, 5G network, a next generation communication network, the Internet, or a computer network (e.g., a LAN or a WAN)). The various types of communication modules may be integrated as one component (e.g., a single chip) or implemented as a plurality of separate components (e.g., multiple chips). In addition or alternative, the distribution device 150 may be implemented as a single chip together with at least one of other components of the server 100.

For example, the server 100 may distribute new reference data to the second mobile device 102 through the distribution device 150.

For example, the distribution device 150 may distribute the new reference data to the second mobile device 102 if the difference between the reference data and the new reference data exceeds a specified range.

For example, the distribution device 150 may distribute the new reference data to the second mobile device 102 based on a specified period. For example, the specified period may be a setting value set by a user.

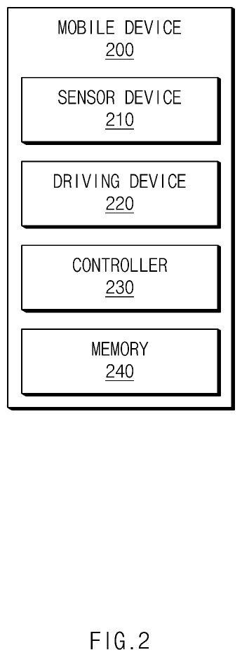

According to an example, the first mobile device 101 and/or the second mobile device 102 may include various type of mobile devices (e.g., mobile robots) that perform driving (e.g., autonomous driving) through a driving device (e.g., a driving device 220) under control of a controller (e.g., a controller 230 of FIG. 2).

For example, the first mobile device 101 may include a first sensor device.

For example, the first sensor device may include at least one of a 3D lidar, a 3D camera, or a combination thereof.

For example, the first mobile device 101 may obtain location information about a specified area by using the first sensor device and transmit the obtained location information to the server 100.

For example, the second mobile device 102 may include a second sensor device.

For example, the second sensor device may include at least one sensor having lower performance (or lower price) than the first sensor device.

For example, the second sensor device may include at least one of a 2D lidar, a 2D camera, or a combination thereof.

For example, the second mobile device 102 may identify (or estimate) the current location of the second mobile device 102 based on the new reference data distributed (or received) from the server 100.

For example, the second mobile device 102 may detect information about at least one landmark existing in a specified area by using the second sensor device.

For example, the second mobile device 102 may estimate the current location of the second mobile device 102 based on at least one of new reference data, information about at least one landmark, or a combination thereof.

For example, the second mobile device 102 may use the second sensor device to identify a first zone in which the second mobile device travels within a specified area.

For example, the second mobile device 102 may use the second sensor device to identify first height information of a first landmark of at least one landmark existing in the first zone.

For example, the second mobile device 102 may use at least one of information, zone landmark identification information, location conversion information, or a combination thereof included in the new reference data to identify location information corresponding to the first height information.

For example, the second mobile device 102 may identify (or estimate) a current location of the second mobile device 102 based on location information.

For example, if it is impossible to identify the location information corresponding to the first height information by using the new reference data, the second mobile device 102 may perform interpolation based on the new reference data to identify the current location of the second mobile device.

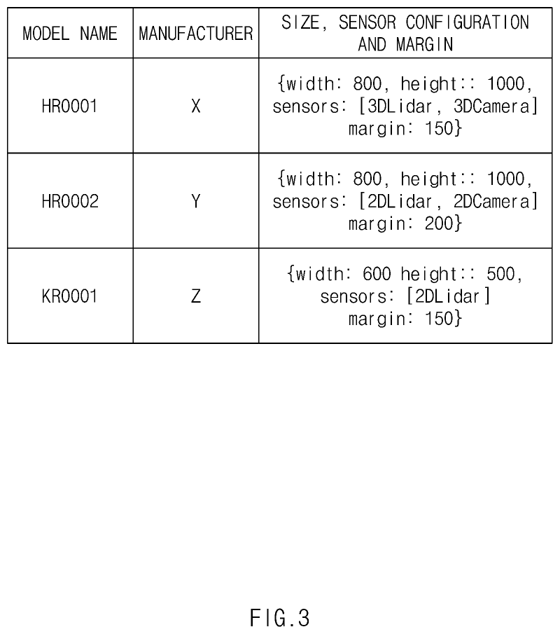

An example of the location estimation operation of the second mobile device 102 may be described in detail later in the description of FIGS. 3 to 6 below.

FIG. 2 shows an example of components of a mobile device according to an example of the present disclosure.

According to an example, a mobile device 200 may include at least one of a sensor device 210, the driving device 220, the controller 230, a memory 240, or a combination thereof. The configuration of the mobile device 200 shown in FIG. 2 is exemplary, and examples of the present disclosure are not limited thereto. For example, the mobile device 200 may further include components (e.g., an interface device, a display device, and/or a communication device) not shown in FIG. 2.

According to an example, the sensor device 210 may obtain (or detect) various pieces of information used for driving of the mobile device 200.

For example, the sensor device 210 may include at least one sensor including at least one of a camera, a radar, a lidar, or a combination thereof.

For example, the sensor device 210 may include at least one of a 3D lidar, a 3D camera, a 2D lidar, a 2D camera, or a combination thereof.

For example, the sensor device 210 may use at least one sensor to obtain information about an external object (e.g., at least one of a person, another vehicle, a building, a structure, or a combination thereof) adjacent to the mobile device 200.

According to an example, the driving device 220 may include components for driving the mobile device 200.

For example, the driving device 220 may include at least one of at least one wheel mounted on one area of the mobile device 200, a driving shaft, a motor, or a combination thereof.

According to an example, the controller 230 may be operatively connected to the sensor device 210, the driving device 220, and/or the memory 240. For example, the controller 230 may control the operations of the sensor device 210, the driving device 220, and/or the memory 240.

For example, the controller 230 may operate the driving device 220 based on at least one of reference data obtained from an external device (e.g., the server 100 of FIG. 1), location information obtained through the sensor device 210, or any combination thereof to control driving of the mobile device 200.

For example, the controller 230 may include a task manager module that controls an operation sequence (or service sequence) of a mobile device. The task manager module may adjust and/or control a sequence of operations (or services) provided by the mobile device 200.

For example, the controller 230 may include a recognition module that processes various information (e.g., image information) obtained through the sensor device 210.

For example, the controller 230 may estimate the current location of the mobile device 200 for driving of the mobile device 200, identify a destination to create a driving route from the current location to the destination, or control the mobile device 200 to avoid an obstacle after detecting the obstacle adjacent to the mobile device 200 during travelling.

According to an example, the memory 240 may store instructions or data. For example, the memory 240 may store one or more instructions that cause the mobile device 200 to perform various operations if executed by the controller 230.

For example, the memory 240 and the controller 230 may be implemented as one chipset. The controller 230 may include at least one of a communication processor or a modem.

For example, the memory 240 may store various information associated with the mobile device 200. For example, the memory 240 may store information about the operation history of the controller 230. For example, the memory 240 may store reference data (e.g., standard reference data) for driving of the mobile device. For example, the memory 240 may store information related to the states and/or operations of components (e.g., at least one of an engine controller (ECU), the sensor device 210, the driving device 220, the controller 230, or a combination thereof) of a mobile device.

Although not shown in FIG. 2, according to an example, the mobile device 200 may further include a communication device (not shown).

For example, the communication device may establish a communication channel (e.g., a wireless communication channel) between the mobile device 200 and an external device (e.g., the server 100 of FIG. 1) and support communication through the established communication channel. For example, the communication device may include one or more communication processors that operate independently from the controller (e.g., an application processor) 230 and support direct (e.g., wired) communication or wireless communication.

For example, the communication device may include a wireless communication module (e.g., a cellular communication module, a near field wireless communication module, or a global navigation satellite system (GNSS) communication module) or a wired communication module (e.g., a local area network (LAN) communication module, or a power line communication module). Among such communication modules, a corresponding communication module may communicate with an external device through a first network (e.g., a near field communication network such as Bluetooth, wireless fidelity (Wi-Fi) direct, or infrared data association (IrDA)) or a second network (e.g., a wide area network such as a legacy cellular network, 5G network, a next generation communication network, the Internet, or a computer network (e.g., a LAN or a WAN)). The various types of communication modules may be integrated as one component (e.g., a single chip) or implemented as a plurality of separate components (e.g., multiple chips). In addition or alternative, the communication device may be implemented as a single chip together with the controller 230.

For example, the mobile device 200 may transmit and (e.g., at least one of location receive various data information obtained through the sensor device 210, new reference data, reference data, or a combination thereof) based on communication with an external device through the communication device.

FIG. 3 shows an example of types of mobile devices and characteristics of each mobile device according to an example of the present disclosure.

Referring to FIG. 3, according to an example, a mobile device that communicates with a server (e.g., the server 100 of FIG. 1) may be implemented in various types of models.

According to an example, a mobile device according to a model name HR0001 may be a mobile device produced by manufacturer ‘X’.

For example, a mobile device according to the model name HR0001 may have a width of 800 mm and a height of 1000 mm.

For example, a mobile device according to the model name HR0001 may include at least one of a 3D lidar, a 3D camera, or a combination thereof. For example, a margin value of data obtained through a sensor of a mobile device according to the model name HR0001 may be 150.

According to an example, a mobile device according to a model name HR0002 may be a mobile device produced by manufacturer ‘Y’.

For example, a mobile device according to the model name HR0002 may have a width of 800 mm and a height of 1000 mm.

For example, a mobile device according to the model name HR0002 may include at least one of a 2D lidar, a 2D camera, or any combination thereof. For example, the margin value of data obtained through a sensor of a mobile device according to the model name HR0002 may be 200.

For example, a mobile device according to the model name HR0002 may include a sensor having relatively low performance (or low price) compared to a mobile device according to the model name HR0001.

According to an example, a mobile device according to a model name KR0001 may be a mobile device produced by manufacturer ‘Z’.

For example, a mobile device according to the model name KR0001 may have a width of 600 mm and a height of 500 mm.

For example, a mobile device according to the model name KR0001 may include a 2D lidar. For example, a margin value of data obtained through a sensor of a mobile device according to the model name KR0001 may be 150.

For example, a mobile device according to the model name KR0001 may include a sensor having relatively low performance (or low price) compared to mobile devices according to the model names HR0001 and HR0002.

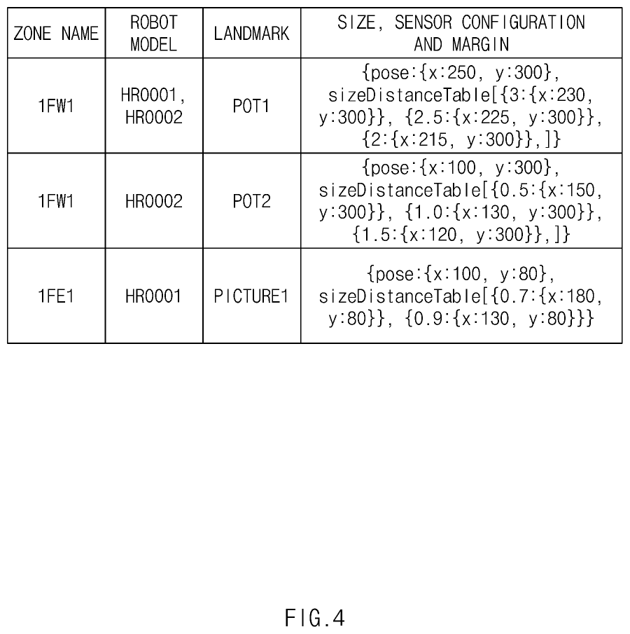

FIG. 4 shows an example of landmarks of a zone in which a mobile device is to travel and characteristics of each mobile device according to an example of the present disclosure.

According to an example, the table shown in FIG. 4 illustrates the name of a zone in which a mobile device is to travel, a model name of a mobile device to travel in the corresponding zone, a landmark existing in the corresponding zone, and location conversion information of the landmark. The mobile device may store table data shown in FIG. 4 in a memory. The table data according to the table shown in FIG. 4 may be, for example, at least a piece of reference data distributed from a server (e.g., the server 100 of FIG. 1).

According to an example, with reference to the first row of the table of FIG. 4, mobile devices according to the model name HR0001 the and model name HR0002 may travel in a zone name ‘1FW1’.

For example, a pot 1 may exist as a landmark in one area of the zone name ‘1FW1’.

For example, location conversion information of the pot 1 existing in the zone name ‘1FW1’ may be x: 250, y: 300.

For example, the height information according to the location of the pot 1 existing in the zone name ‘1FW1’ may be {3: {x: 230, y: 300}, {2.5: {x: 225, y: 300}, and {2: {x: 215, y: 300} }.

For example, if the height of the pot 1 detected through the sensor by a mobile device traveling in the zone name ‘1FW1’ is 3, the current location (or coordinates) of the mobile device may be x: 230 and y: 300.

For example, if the height of the pot 1 detected through a sensor by a mobile device travelling in the zone name ‘1FW1’ is 2.5, the current location of the mobile device may be x: 225 and y: 300.

For example, if the height of the pot 1 detected through a sensor by a mobile device traveling in the zone name ‘1FW1’ is ‘2’, the current location of the mobile device may be x: 215 and y: 300.

Referring to the second row of the table of FIG. 4, according to an example, in the zone name ‘1FW1’, a mobile device according to the model name HR0002 may travel.

For example, a pot 2 may exist as a landmark in one region of the zone name ‘1FW1’.

For example, location conversion information of the pot 2 existing in the zone name ‘1FW1’ may be x: 100 and y: 300.

For example, the height information according to the location of the pot 2 existing in the zone name ‘1FW1’ is {0.5: {x: 150, y: 300} }, {1.0: {x: 130, y: 300} } and {1.5: {x: 120, y: 300} }.

For example, if the height of the pot 2 detected through a sensor by a mobile device traveling in the zone name ‘1FW1’ is 0.5, the current location of the mobile device may be x: 150 and y: 300.

For example, if the height of the pot 2 detected through a sensor is 1.0 by a mobile device traveling in the zone name ‘1FW1’, the current location of the mobile device may be x: 130 and y: 300.

For example, if the height of the pot 2 detected through a sensor by a mobile device traveling in the zone name ‘1FW1’ is 1.5, the current location of the mobile device may be x: 120 and y: 300.

Referring to the third row of the table of FIG. 4, according to an example, in a zone name ‘1FE1’, a mobile device according to the model name HR0001 may travel.

For example, a picture 1 may exist as a landmark in one region of the zone name ‘1FE1’.

For example, the location conversion information of the picture 1 existing in the zone name ‘1FE1’ may be x: 100 and y: 80.

For example, the height information according to the location of the picture 1 existing in the zone name ‘1FE1’ may be {0.7: {x: 180, y: 80} } and {0.9: {x: 130, y: 80} }.

For example, if the height of the picture 1 detected through a sensor by a mobile device traveling in the zone name ‘1FE1’ is 0.7, the current location of the mobile device may be x: 180 and y: 80.

For example, if the height of the picture 1 detected through a sensor by a mobile device traveling in the zone name ‘1FE1’ is 0.9, the current location of the mobile device may be x: 130 and y: 80.

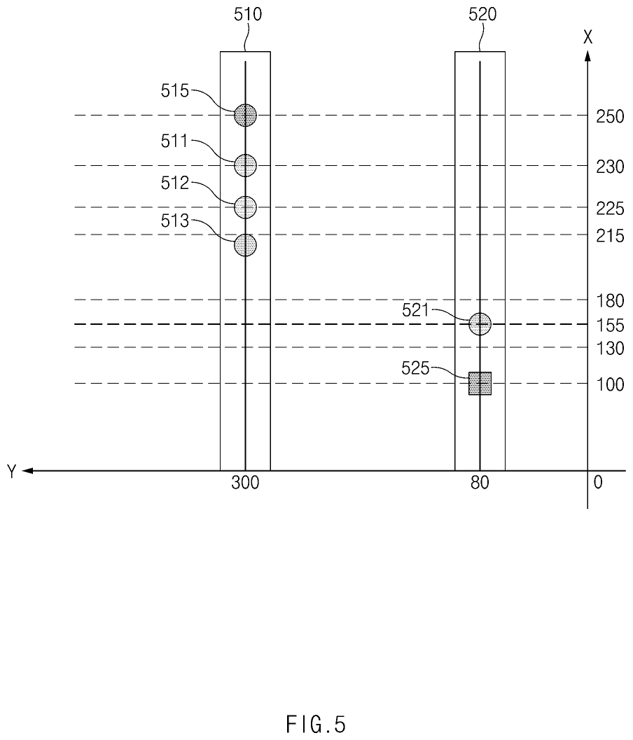

FIG. 5 shows an example of a location estimation operation of a mobile device according to an example of the present disclosure.

Referring to FIG. 5, according to an example, a mobile device may estimate its current location in various driving environments.

According to an example, in a first area 510 (e.g., the zone ‘1FW1’ of FIG. 4), the mobile device may estimate its location. For example, the first area 510 may be a corridor.

For example, a mobile device traveling in the first area 510 may obtain information about a first landmark 515 (e.g., the pot 1 in FIG. 4) by using a sensor.

For example, the mobile device traveling in the first area 510 may use height information of the first landmark 515 obtained using a sensor and pre-stored table data (or, reference data) shown in FIG. 4 to identify one of a first point 511, a second point 512, or a third point 513 as its location.

For example, if the height of the obtained first landmark 515 is ‘3’, the mobile device may estimate that its current location is the first point 511 by using the table data. For example, the coordinates of the first point 511 may be x: 230 and y: 300.

For example, if the height of the obtained first landmark 515 is 2.5, the mobile device may estimate that its current location is the second point 512 by using table data. For example, the coordinates of the second point 512 may be x: 225 and y: 300.

For example, if the height of the obtained first landmark 515 is 2, the mobile device may estimate that its current location is the third point 513 by using table data. For example, the coordinates of the third point 513 may be x: 215 and y: 300.

For example, if the mobile device cannot identify location information corresponding to the height information of the first landmark 515 in the table data, the mobile device may perform interpolation based on the table data to identify the current locate.

According to an example, in a second area 520 (e.g., the zone ‘1FE1’ of FIG. 4), the mobile device may estimate its location. For example, the second area 520 may be a corridor.

For example, a mobile device traveling in the second area 520 may obtain information about a second landmark 525 (e.g., the picture 1 of FIG. 4) by using a sensor.

For example, the mobile device traveling in the second area 520 may use height information of the second landmark 525 obtained using a sensor and use pre-stored table data (or, reference data) shown in FIG. 4 to identify its location.

For example, if the height of the obtained second landmark 525 is 0.7, the mobile device may estimate that the coordinates of the current location thereof are x: 180 and y: 80 by using the table data.

For example, if the height of the obtained second landmark 525 is 0.9, the mobile device may estimate that the coordinates of the current location thereof are x: 130 and y: 80 by using the table data.

For example, if the mobile device cannot identify location information corresponding to the height information of the second landmark 525 in the table data, the mobile device may perform interpolation based on the table data to identify the current location. For example, if the height of the obtained second landmark 525 is 0.8, the mobile device may estimate that the current location is an estimated point 521 through interpolation based on the data obtained by the mobile device and the table data. For example, the estimated point 521 may be x: 155 and y: 80.

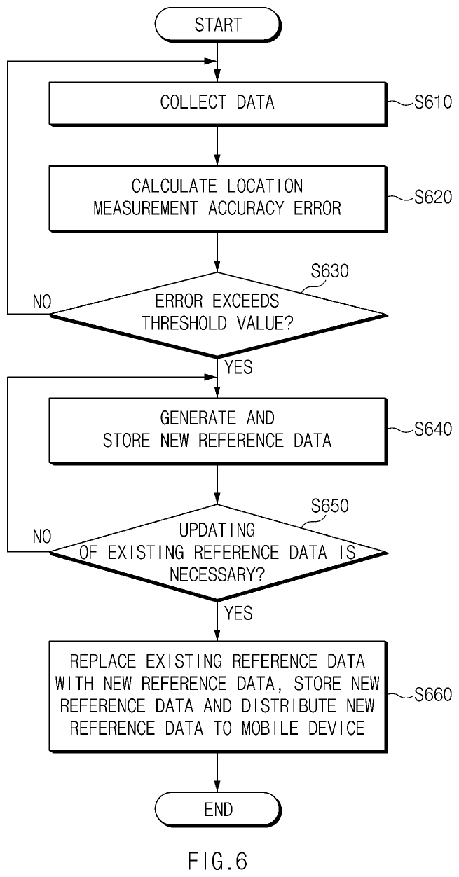

FIG. 6 shows an example of an operation of a location estimation server according to an example of the present disclosure.

A location estimation server (e.g., the server 100 of FIG. 1) may perform the operations disclosed in FIG. 6. For example, at least some of the location estimation server (e.g., the data collection device 110, the data storage device 120, the accuracy verification device 130, the location measurement update device 140, and the distribution device 150 of FIG. 1) may be set to perform the operations of FIG. 6.

In the following example, the operations of S610 to S660 may be sequentially performed, but are not necessarily sequentially performed. For example, the order of each operation may be changed, or at least two operations may be performed in parallel. In addition or alternative, contents corresponding to or overlapping with the contents described above with respect to FIG. 6 will be briefly described or omitted.

According to one example, the location estimation server may collect data in S610.

For example, the location estimation server may collect location information obtained by the mobile device using a sensor device, from at least some of various types of mobile devices.

For example, the location estimation server may periodically collect location information obtained by a first mobile device (e.g., the first mobile device 101 of FIG. 1) including a sensor having relatively high location measurement accuracy or a relatively high price among various types of mobile devices during travelling.

For example, the collected data may include at least one of a driving environment (e.g., area name, corridor name, or the like) in which the first mobile device is driven, raw data (e.g., an image, a video, or the like) used for location estimation, and data (e.g., an image, a video, a processing result, or the like) used for OCR, 2D lidar data, 3D lidar data, or a combination thereof.

According to an example, the location estimation server may calculate a location measurement accuracy error in S620.

For example, the location estimation server may compare the collected location information with existing reference data being used by the second mobile device for driving, and calculate an error in location measurement accuracy.

According to an example, in S630, the location estimation server may determine whether the error exceeds a threshold value.

For example, if the error exceeds a threshold value (e.g., operation S630—Yes), the location estimation server may perform operation S640.

For example, if the error does not exceed the threshold value (e.g., operation S630—No), the location estimation server may repeat operation S610.

According to an example, in S640, the location estimation server may generate and store new reference data.

For example, the location estimation server may generate new reference data by using one of image data, lidar data, OCR data, or a combination thereof included in existing reference data.

For example, the location estimation server may identify image data included in location information collected from the first mobile device. The location estimation server extracts at least one feature included in image data, and may generate new reference data by replacing at least some data included in existing reference data with extracted features or by updating the existing reference data using the extracted features.

As an example, the location estimation server may use image data (or at least one image data) included in the location information collected from the first mobile device to update at least one machine learning model included in a location measurement update device (e.g., the location measurement update device 140 in FIG. 1). At least one machine learning model may perform an operation of generating reference data.

For example, the location estimation server may identify OCR data included in the location information collected from the first mobile device. The location estimation server may compare the identified OCR data with the existing OCR data included in the existing reference, and if the difference exceeds a threshold value, may generate and store new reference data by replacing the existing OCR data with the identified OCR data or updating the existing OCR data using the identified OCR data.

For example, the location estimation server may identify lidar data included in the location information collected from the first mobile device. The location estimation server may compare the identified lidar data with the existing lidar data included in the existing reference, and if the difference exceeds a threshold value, may generate and store new reference data by replacing the existing lidar data with the identified lidar data or updating the existing lidar data using the identified lidar data.

For example, the location estimation server may separately store generated new reference data from existing reference data.

According to an example, in S650, the location estimation server may determine whether it is to update the existing reference data.

For example, the location estimation server may replace the existing reference data with the new reference data and store the new reference data based on a specified period. In this case, the existing reference data may be deleted from a memory (e.g., the data storage device 120 of FIG. 1).

For example, if the difference between the existing reference data and the new reference data exceeds a specified range, the location estimation server may replace the existing reference data with the new reference data and store the new reference data. In this case, the existing reference data may be deleted from a memory (e.g., the data storage device 120 of FIG. 1).

For example, if it is determined that updating of existing reference data is to be performed (e.g., operation S650—Yes), the location estimation server may perform operation S660.

For example, if it is determined that updating of existing reference data is not to be performed (e.g., operation $650—No), the location estimation server may perform operation S640.

According to an example, in S660, the location estimation server may replace the existing reference data with the new reference data, store the new reference data in a memory, and distribute the new reference data to a mobile device.

For example, the location estimation server may distribute (or transmit) the new reference data to the second mobile device (e.g., the second mobile device 102 of FIG. 1).

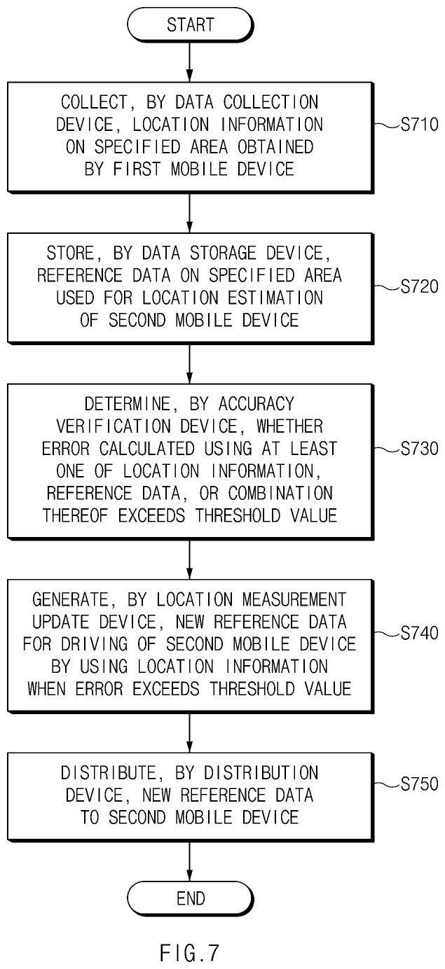

FIG. 7 shows an example of an operation of a location estimation server according to an example of the present disclosure.

A location estimation server (e.g., the server 100 of FIG. 1) may perform the operations disclosed in FIG. 7. For example, at least some of the location estimation server (e.g., the data collection device 110, the data storage device 120, the accuracy verification device 130, the location measurement update device 140, and the distribution device 150 of FIG. 1) may be set to perform the operations of FIG. 7.

In the following example, the operations of S710 to S750 may be sequentially performed, but are not necessarily sequentially performed. For example, the order of each operation may be changed, or at least two operations may be performed in parallel. In addition or alternative, contents corresponding to or overlapping with the contents described above with respect to FIG. 7 will be briefly described or omitted.

According to an example, the location estimation method may include S710 of collecting, by a data collection device, location information on a specified area obtained by a first mobile device.

According to an example, the location estimation method may include S720 of storing, by a data storage device, reference data on the specified area used for location estimation of a second mobile device.

According to an example, the location estimation method may include S730 of determining, by an accuracy verification device, whether an error calculated using at least one of the location information, the reference data, or a combination thereof exceeds a threshold value.

According to an example, the location estimation method may include S740 of generating, by a location measurement update device, new reference data for driving of the second mobile device by using the location information if the error exceeds the threshold value.

For example, the generating of the new reference data by the location measurement update device may include extracting, by the location measurement update device, at least one feature from at least one image included in the location information, and generating, by the location measurement update device, the new reference data that includes the at least one feature and is distinguished from the reference data and storing the new reference data in a separate memory distinguished from the data storage device, or generating, by the location measurement update device, the new reference data by replacing a reference feature included in the reference data with the at least one feature and storing the new reference data in the data storage device.

For example, the generating of the new reference data by the location measurement update device may include generating, by the location measurement update device, the new reference data that includes at least one of 2D lidar data, 3D lidar data or a combination thereof included in the location information and is distinguished from the reference data and storing the new reference a data in separate memory distinguished form the data storage device, or replacing, by the location measurement update device, reference lidar data included in the reference data with at least one of the 2D lidar data, the 3D lidar data or a combination thereof, generating the new reference data and storing the new reference data in the data storage device.

For example, the location measurement update device includes at least one machine learning model for generating at least one reference data.

For example, the generating of the new reference data by the location measurement update device may include updating, by the location measurement update device, the at least one machine learning model by using at least one image included in the location information as learning data for the at least one machine learning model if the error exceeds the threshold value.

According to an example, the location estimation method may include S750 of distributing, by a distribution device, the new reference data to the second mobile device.

For example, the distributing of the new reference data by the distribution device may include distributing, by the distribution device, the new reference data to the second mobile device if a difference between the reference data and the new reference data exceeds a specified range or based on a specified period.

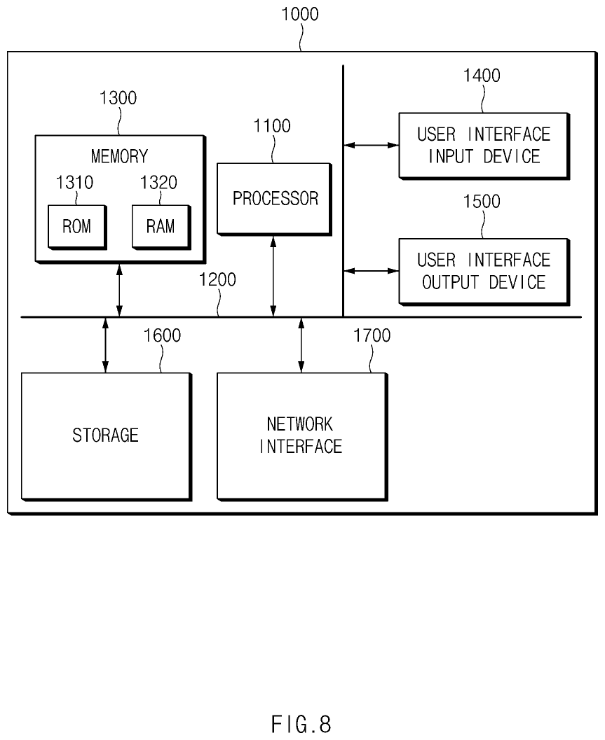

FIG. 8 shows an example of a computing system for executing a location estimation method according to an example of the present disclosure.

Referring to FIG. 8, a computing system 1000 related to a location estimation method may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM 1310 (Read Only Memory) and a RAM 1320 (Random Access Memory).

Accordingly, the processes of the method or algorithm described in relation to the examples of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The present disclosure has been made to solve the above-mentioned problems occurring in the prior art while advantages achieved by the prior art are maintained intact.

An example of the present disclosure provides a location estimation server capable of communicating with a first mobile device and a second mobile device that include different types of sensors, collecting location information about a specified area obtained by the first mobile device, and generating new reference data by using reference data for estimating a location of the second mobile device and the location information obtained by the first mobile device, a system including the same, and a method thereof.

Another example of the present disclosure provides a location estimation server capable of collecting location information about a specified area from a first mobile device including a sensor having relatively improved performance, and generating new reference data for driving of a second mobile device including a sensor having relatively low performance through it, a system including the same, and a method thereof.

Still another example of the present disclosure provides a location estimation server capable of replacing reference data with new reference data and storing the new reference data if the difference between the new reference data and the reference data exceeds a specified range or a specified period has elapsed, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a location estimation server includes a data collection device that collects location information obtained by a first mobile device about a specified area, a data storage device that stores reference data on the specified area used for location estimation of a second mobile device, an accuracy verification device that determines whether an error calculated using at least one of the location information, the reference data, or a combination thereof exceeds a threshold value, a location measurement update device that generates new reference data for driving of the second mobile device by using the location information if the error exceeds the threshold value, and a distribution device that distributes the new reference data to the second mobile device.

According to an example, the data collection device may allow the first mobile device to collect the location information obtained about the specified area by using a first sensor device, and the data storage device may store the reference data used for driving of the second mobile device including a second sensor device having lower performance than the first sensor device.

According to an example, the data storage device may replace the reference data with the new reference data and store the new reference data if a difference between the reference data and the new reference data exceeds a specified range or based on a specified period.

According to an example, the location information may include at least one of identification information of at least one corridor included in the specified area, at least one image used for estimating a location of the first mobile device, an optical character recognition (OCR) recognition result based on the at least one image, 2D lidar data, 3D lidar data, or a combination thereof.

According to an example, the accuracy verification device may calculate the error between at least some of the data included in the location information and data on the specified area included in the reference data.

According to an example, the at least one of the reference data, the new reference data, or the combination thereof may include at least one of identification information of the at least one corridor included in the specified area, a location of at least one landmark, location conversion information calculated based on the location of the at least one landmark, or a combination thereof.

According to an example, the location measurement update device may extract at least one feature from at least one image included in the location information, and generate the new reference data that includes the at least one feature and is distinguished from the reference data and store the new reference data in a separate memory distinguished from the data storage device, or generate the new reference data by replacing a reference feature included in the reference data with the at least one feature and store the new reference data in the data storage device.

According to an example, the location measurement update device may generate the new reference data that includes at least one of 2D lidar data, 3D lidar data or a combination thereof included the in location information and is distinguished from the reference data, and store the new reference data in a separate memory distinguished form the data storage device, or replace reference lidar data included in the reference data with at least one of the 2D lidar data, the 3D lidar data or a combination thereof to generate the new reference data, and store the new reference data in the data storage device.

According to an example, the location measurement update device may include at least one machine learning model for generating at least one reference data, and is configured to update the at least one machine learning model by using at least one image included in the location information as learning data for the at least one machine learning model if the error exceeds the threshold value.

According to an example, the distribution device may distribute the new reference data to the second mobile device if a difference between the reference data and the new reference data exceeds a specified range or based on a specified period.

According to another example of the present disclosure, a location estimation system includes a first mobile device that obtains location information about a specified area by using a first sensor device, a server that collects the location information from the first mobile device, stores reference data for the specified area used for location estimation of a second mobile device, generates new reference data for driving of the second mobile device by using the location information if an error between location information and the reference data exceeds a threshold value, and distributes the new reference data to the second mobile device, and a second mobile device that includes a second sensor having lower performance than the first sensor and identifies a current location based on the new reference data distributed from the server.

According to an example, the second mobile device may sense information about at least one landmark existing in the specified area by using the second sensor device, and estimate the current location of the second mobile device based on at least one of the new reference data, the information about the at least one landmark, or a combination thereof.

According to an example, the second mobile device may identify a first zone in which the second mobile device travels in the specified area by using the second sensor device, identify first height information of a first landmark existing in the first zone among the at least one landmark by using the second sensor device, identify location information corresponding to the first height information by using at least one of zone information included in the new reference data, landmark identification information, location conversion information, or a combination thereof, and identify the current location of the second mobile device based on the location information.

According to an example, the second mobile device may identify the current location of the second mobile device by performing interpolation based on the new reference data if the location information corresponding to the first height information is not identified using the new reference data.

According to an example, the first sensor device may include at least one of a 3D lidar, a 3D camera, or a combination thereof, and the second sensor device may include at least one of a 2D lidar, a 2D camera, or a combination thereof.

According to still another example of the present disclosure, a location estimation method includes collecting, by a data collection device, location information obtained by a first mobile device about a specified area, storing, by a data storage device, reference data on the specified area used for location estimation of a second mobile device, determining, by an accuracy verification device, whether an error calculated using at least one of the location information, the reference data, or a combination thereof exceeds a threshold value, generating, by a location measurement update device, new reference data for driving of the second mobile device by using the location information if the error exceeds the threshold value, and distributing, by a distribution device, the new reference data to the second mobile device.

According to an example, the generating of the new reference data by the location measurement update device may include extracting, by the location measurement update device, at least one feature from at least one image included in the location information, and generating, by the location measurement update device, the new reference data that includes the at least one feature and is distinguished from the reference data and storing the new reference data in a separate memory distinguished from the data storage device, or generating, by the location measurement update device, the new reference data by replacing a reference feature included in the reference data with the at least one feature and storing the new reference data in the data storage device.

According to an example, the generating of the new reference data by the location measurement update device may include generating, by the location measurement update device, the new reference data that includes at least one of 2D lidar data, 3D lidar data or a combination thereof included in the location information and is distinguished from the reference data and storing the new reference data in a separate memory distinguished form the data storage device, or replacing, by the location measurement update device, reference lidar data included in the reference data with at least one of the 2D lidar data, the 3D lidar data or a combination thereof to generate the new reference data and storing the new reference data in the data storage device.

According to an example, the location measurement update device may include at least one machine learning model for generating at least one reference data, and the generating of the new reference data by the location measurement update device may include updating, by the location measurement update device, the at least one machine learning model by using at least one image included in the location information as learning data for the at least one machine learning model if the error exceeds the threshold value.

According to an example, the distributing of the new reference data by the distribution device may include distributing, by the distribution device, the new reference data to the second mobile device if a difference between the reference data and the new reference data exceeds a specified range or based on a specified period.

Effects of a location estimation server, a system including the same, and a method thereof according to the examples of the present disclosure will be described below.

According to at least one of the examples of the present disclosure, it is possible to provide measured location information for accurate location estimation of a mobile device at a place where the accuracy of location estimation (or location measurement) is relatively low due to a repeated pattern such as a corridor.

In addition or alternative, according to at least one of the examples of the present disclosure, it is possible to provide measured location information generated by using information obtained by using a mobile device including a sensor having a relatively high price (or high accuracy), to a mobile device including a sensor having a relatively low price (or low accuracy).

In addition or alternative, according to at least one of the examples of the present disclosure, although there is a limit to the kind or type of sensor that can be mounted on a mobile device, the location estimation server may store and generate more accurate location information, and may provide location information (or, new reference data) generated based on comparison with periodically or previously stored location information to at least one mobile device.

In addition or alternative, various effects that are directly or indirectly understood through the present disclosure may be provided.

Although examples of the present disclosure have been described for illustrative purposes, those skilled in the art will appreciate that various modifications, additions and substitutions are possible, without departing from the scope and spirit of the disclosure.

Therefore, the examples disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A server comprising:
one or more processors; and
memory storing instructions that, when executed by the one or more processors, cause the server to:
collect, from a first mobile device, location information associated with a specified area;
store reference data, associated with a relative location between a second mobile device and the specified area;
determine, based on at least one of the location information or the stored reference data, whether an error calculated satisfies a threshold value;
generate, based on the determination, new reference data; and
cause, based on the new reference data and the location information, the second mobile device to adjust driving direction.

2. The server of claim 1, wherein the instructions, when executed by the one or more processors, further cause the server to cause the first mobile device to collect, by a first sensor device, the location information;
wherein the stored reference data is used to control driving the second mobile device; and
wherein a second sensor device, associated with the second mobile device, has a lower performance than the first sensor device.

3. The server of claim 1, wherein the instructions, when executed by the one or more processors, further cause the server to replace the stored reference data with the new reference data based on:
a difference between the stored reference data and the new reference data satisfying a specified range; or
a specified period of time.

4. The server of claim 1, wherein the location information includes at least one of:
identification information f at least corridor included in the specified area,
at least one image used for estimating a location of the first mobile device,
an optical character recognition (OCR) result based on the at least one image,
2 dimensional lidar data, or
3 dimensional lidar data.

5. The server of claim 4, wherein the instructions, when executed by the one or more processors, further cause the server to calculate the error based on data included in the location information and data included in the stored reference data.

6. The server of claim 1, wherein the at least one of the stored reference data or the new reference data includes at least one of:
identification information of at least one corridor included in the specified area,
a location of at least one landmark, or
location conversion information that is based on the location of the at least one landmark.

7. The server of claim 1, wherein the instructions, when executed by the one or more processors, further cause the server to:
extract at least one feature from at least one image included in the location information; and
generate the new reference data that includes the at least one feature and is different from the stored reference data, and store the new reference data separately from the stored reference data; or
generate the new reference data by replacing a reference feature included in the stored reference data with the at least one feature.

8. The server of claim 1, wherein the instructions, when executed by the one or more processors, further cause the server to:
generate the new reference data that includes at least one of 2 dimensional (2D) lidar data or 3 dimensional (3D) lidar data included in the location information and is different from the stored reference data, and store the new reference data separately from the stored reference data; or
generate the new reference data by replacing reference lidar data included in the stored reference data with at least one of the 2D lidar data or the 3D lidar data.

9. The server of claim 1, wherein the instructions, when executed by the one or more processors, further cause the server to:
update at least one machine learning model based on at least one image included in the location information as learning data and the error satisfying the threshold value; and
generate, based on the updated at least one machine learning model, at least one reference datum.

10. The server of claim 1, wherein the instructions, when executed by the one or more processors, further cause the server to distribute the new reference data to the second mobile device based on:
a difference between the stored reference data and the new reference data satisfying a specified range; or
a specified period of time.

11. A system comprising:
a first mobile device configured to obtain, by a first sensor device, location information associated with a specified area;
a server configured to:
collect the location information from the first mobile device,
store reference data, associated with a relative location between a second mobile device and the specified area,
generate new reference data based on the location information and an error associated with the location information and the stored reference data satisfying a threshold value, and
distribute the new reference data to the second mobile device; and
the second mobile device associated with a second sensor device having lower performance than the first sensor device and the second sensor device configured to identify a current location information based on the new reference data distributed from the server.

12. The system of claim 11, wherein the second mobile device is configured to:
sense, by the second sensor device, information associated with at least one landmark existing in the specified area, and
estimate a current location of the second mobile device based on at least one of the new reference data or the information associated with the at least one landmark.

13. The system of claim 12, wherein the second mobile device is configured to:
identify, by the second sensor device, a first zone in which the second mobile device travels in the specified area;
identify, by the second sensor device, first height information associated with a first landmark, among the at least one landmark, existing in the first zone;
identify location information corresponding to the first height information based on at least one of zone information included in the new reference data, landmark identification information, or location conversion information; and
identify the current location of the second mobile device based on the location information.

14. The system of claim 13, wherein the second mobile device is configured to:
perform interpolation based on the new reference data if the first height information is not identified in the new reference data; and
identify, based on the interpolation, the current location of the second mobile device.

15. The system of claim 11, wherein the first sensor device includes at least one of a 3 dimensional (3D) lidar or a 3D camera, and
wherein the second sensor device includes at least one of a 2 dimensional (2D) lidar or a 2D camera.

16. A method comprising:
collecting, by a server from a first mobile device, location information associated with a specified area;
storing reference data, associated with a relative location between a second mobile device and the specified area;
determining, based on at least one of the location information or the stored reference data, whether an error calculated satisfies a threshold value;
generating, based on the determination, new reference data; and
causing, based on the new reference data and the location information, the second mobile device to adjust driving direction.

17. The method of claim 16, wherein the generating the new reference data comprises:
extracting at least one feature from at least one image included in the location information; and
generating the new reference data that includes the at least one feature and is different from the stored reference data and, storing the new reference data separately from the stored reference data; or
generating the new reference data by replacing a reference feature included in the stored reference data with the at least one feature.

18. The method of claim 16, wherein the generating of the new reference data comprises:
generating the new reference data that includes at least one of 2 dimensional (2D) lidar data or 3 dimensional (3D) lidar data included in the location information and is different from the stored reference data, and storing the new reference data separately from the stored reference data; or
generating the new reference data by replacing reference lidar data included in the stored reference data with at least one of the 2D lidar data or the 3D lidar data.

19. The method of claim 16,
wherein the generating the new reference data comprises:
updating at least one machine learning model based on at least one image included in the location information as learning data and the error satisfying the threshold value; and
generating, based on the updated at least one machine learning model, at least one reference datum.

20. The method of claim 16 further comprising:
distributing the new reference data to the second mobile device based on:
a difference between the stored reference data and the new reference data satisfying a specified range; or
a specified period of time.
